(19) United States
(12) Patent Application Publication
(10) Pub. No.: US 2007/0226154 A1
(43) Pub. Date: Sep. 27, 2007

(54) METHOD INTEGRATING ANNUITIES, MORTALITY CONTINGENT BONDS AND DERIVATIVES, FOR BENEFITING CHARITABLE ORGANIZATIONS

(76) Inventor: Thomas M. Palmieri, Higley, AZ (US)

Correspondence Address: WEISS & MOY PC, 4204 NORTH BROWN AVENUE, SCOTTSDALE, AZ, 85251, US

(21) Appl. No.: 11/277,566

(22) Filed: Mar. 27, 2006

(51) Int. Cl. G06Q 40/00

(52) U.S. Cl. 705/36 T; 705/36 R

(57) ABSTRACT

A method for benefiting charitable organizations integrating annuities, mortality contingent bond or other mortality-hedging derivative. A plurality of donors is grouped into a block, each donor in the block selecting at least one benefiting charity. At least one lending entity issues a mortality contingent bond loan or a derivative loan to a qualified tax-exempt charitable organization that then uses funds from the mortality contingent bond loan or the derivative loan to purchase annuities from at least one commercial life insurance company. The donors are named as the annuitants of the annuities. The qualified tax-exempt charitable organization will then use funds from the annuity payments to amortize the mortality contingent bond loan or the derivative loan and will also donate a portion of the annuity payments to the benefiting charities selected by the block of donors. The qualified tax-exempt charitable organization may also donate a portion of funds from the mortality contingent bond loan or the derivative loan to the benefiting charities shortly after funding of the mortality contingent bond loan or the derivative loan.

### FIELD OF THE INVENTION

This invention relates generally to fund-raising, and more specifically, a method for benefiting charitable organizations integrating annuities, mortality contingent bonds, and other mortality hedging derivatives.

### BACKGROUND OF THE INVENTION

An annuity is an investment which pays the investor an income for a specified period of time. An annuity may be used as a form of an investment wherein an individual pays a lump sum to a financial institution, e.g. a commercial life insurance company or a bank, to purchase an annuity. The investor may or may not be the annuitant of the annuity. Once annuitized, the financial institution pays the investor a regular scheduled income for a predetermined period of time. If the investor chooses a life-only payout option, the payments will continue for the rest of the annuitant's life. Upon the death of the annuitant, the annuity payments would cease. Naturally, the longer the annuitant lives, the more annuity payments the financial institution that issues the life-only annuity will have to make. This risk associated with predictions of the incidence or non-incidence of death is often referred to as the “mortality risk.”

Issuers of life-only annuities may hedge their aggregate mortality risk by transferring it to the financial markets through newly-available mortality-contingent bonds. Typically these mortality contingent bonds are based on the overall mortality of the population of several countries which may create “basis risk” to the annuity provider since the mortality is not specifically hedging the group of annuitants with the annuity provider, but nonetheless, provide the annuity provider with a hedge against a portion of its mortality risk.

Survivor swaps have also been used to manage mortality risk by life and annuity providers. A conventional swap usually involves an interest-rate swap, one portion of which stipulates a fixed payment schedule, and the other portion stipulates a random, interest-dependent payment schedule. A survivor swap, therefore, is a swap wherein certain payments depend on a random mortality variable.

Not-for-profit organizations depend greatly, if not entirely, upon donations and grants from its donors. After many years of donating to charities, however, donors oftentimes experience “donor fatigue”. Not-for-profit organizations are therefore in need of an alternative form of generating revenue that is not always dependent on its donor's direct donations. Since annuities are often used by charities to raise money for future endowments, e.g. Charitable Gift Annuities and Charitable Annuity Trusts, one method for a charity to raise money could be to borrow money from a bank or finance company to purchase life-annuities on its donor's lives, using the financed annuities as collateral for the loan. Since the life-annuity income would cease at the death of the donor, the charity would incur mortality risk and may not have sufficient funds to repay the loan to the lender.

Therefore, a need existed for a method that allowed a charity to finance life-annuities on the lives of its donors and that give the assurance that the loan will be repaid to the lender regardless of when their donors actually die. This method would preferably allow the charity to use some of the annuity income to further its charitable purpose without having to solely rely on the continued donations from its donors. Further preferably, this method would allow a charitable organization to finance a life-annuity, naming its donors as the annuitants, using a mortality contingent bond or derivative as the source of financing. Still further preferably, the mortality contingent bond or derivative would transfer the mortality risk of the financed life-annuities to the financial market thus allowing the charity to fully repay its debt to the bond holders, regardless of how long their donors live. Still further preferably, since the charity used in the method is a registered 501(c)(3) tax-exempt organization, specifically chartered to conduct the activities of financing annuities on the lives of its donors, it is not subject to income taxes on the annuity payments, allowing the process to be even more financially efficient in raising money for its charitable purpose.

### SUMMARY OF THE INVENTION

An object of the present invention is to provide a method for benefiting charitable organizations without any cost or financial liability on its part.

Another object of the present invention is to provide a method wherein a qualified 501(3)(c) tax-exempt charitable organization will acquire funds from a mortality contingent bond or derivative to purchase annuities on several donors' lives to create a financial benefit for other charitable organizations.

Another object of the present invention is to provide a method wherein the qualified tax-exempt charitable organization will use funds received from scheduled annuity payments to amortize the mortality contingent bond or derivative loan.

Another object of the present invention is to provide a method wherein the qualified tax-exempt charitable organization will use funds from scheduled annuity payments to benefit the donors' selected charitable organizations.

Still another object of the present invention is to provide a method that could allow each donor's selected charitable organization to continue to receive those benefits regardless of whether that particular donor is living.

Yet another object of the present invention is to provide a method that would allow bond holders to participate and financially benefit from the trend of decreasing mortality within the group of annuitants who participate in the program. If the overall mortality was increased on the block of donors/annuitants over the financing period, the investors could experience a decreased interest rate and possibly a loss of principle. If the overall mortality was decreased on the block of donors/annuitants over the financing period, the investors could experience an increase in their anticipated interest rates.

Another object of the present invention is to provide a method wherein the design and charter of the qualified tax-exempt 501(c)(3) organization that allows for its charitable purpose to be the financing of annuities on donors' lives to create a benefit for other tax-exempt organizations. This design and charter allows for its activity to avoid being subject to an income tax which would likely be imposed on other tax-exempt 501(c)(3) organizations that do not specifically contain this activity within its charter.

### BRIEF DESCRIPTION OF THE PREFERRED EMBODIMENTS

In accordance with a first embodiment of the present invention, a method of making contributions to charitable organizations is disclosed. The method comprises the steps of selecting a benefiting charity by a donor, providing a qualified tax-exempt charitable organization, issuing by a first financial institution at least one of a mortality contingent bond loan and a derivative loan to the qualified tax-exempt charitable organization, purchasing by the qualified tax-exempt charitable organization of at least one annuity from a second financial institution with at least a portion of funds from the at least one of a mortality contingent bond loan and a derivative loan, issuing by the second financial institution of at least one annuity to the qualified tax-exempt charitable organization, paying by the second financial institution of annuity payments to the qualified tax-exempt charitable organization, amortizing by the tax-exempt charitable organization of the at least one of a mortality contingent bond loan and a derivative loan with at least a portion of the annuity payments received from the second financial institution, and donating by the tax-exempt charitable organization of at least another portion of the annuity payments received from the second financial institution to the benefiting charity, selected by the participating donor.

In accordance with another embodiment of the present invention, a method of making contributions to charitable organizations is disclosed. The method comprises the steps of providing at least one benefiting charity selected by at least one of a plurality of donors, providing a qualified tax-exempt charitable organization, issuing by at least one lending entity of at least one a mortality contingent bond loan and a derivative loan to the qualified tax-exempt charitable organization, purchasing by the qualified tax-exempt charitable organization of a plurality of annuities from at least one commercial life insurance company with at least a portion of funds from the at least one of a mortality contingent bond loan and a derivative loan, issuing by the at least one commercial life insurance company of the plurality of annuities to the qualified tax-exempt charitable organization, paying by the at least one commercial life insurance company of annuity payments to the qualified tax-exempt charitable organization, amortizing by the tax-exempt charitable organization of the at least one of a mortality contingent bond loan and a derivative loan with at least a portion of the annuity payments received from the at least one commercial life insurance company, and donating by the tax-exempt charitable organization of at least another portion of the annuity payments received from the at least one commercial life insurance company to the at least one benefiting charity.

### BRIEF DESCRIPTION OF THE DRAWINGS

FIG. 1 is a block diagram depicting the method for benefiting charitable organizations in accordance with an embodiment of the present invention.

FIG. 2 is a block diagram depicting steps of the method of FIG. 1 by which a donor's selected charity will receive benefits. The donation is shown as coming from a portion of the mortality contingent bond loan or the derivative loan received by the benefiting charity from the lending entity.

FIG. 3 is a block diagram depicting steps of the method of FIG. 1 by which a donor's selected charity will receive benefits. The donation is shown as coming from the annuity payments received by the qualified tax-exempt charitable organization from the commercial life insurance company, after the loan is fully repaid.

FIG. 4 is a block diagram showing the funding and repayment of the mortality contingent bond loan or the derivative loan of the method of FIG. 1 occurring between the lending entity (mortality contingent bond or derivative issuer) and the qualified charitable entity and the qualified charitable entity and the life insurance company (annuity issuer). Also shown is the financial relationship between bond investors and the bond issuer/lending entity.

FIG. 5 is a sample chart showing the amortization of a mortality contingent bond loan or a derivative loan with the annuity payments. Also shown are the immediate donations made to the donors' selected charities from the mortality contingent bond loan or the derivative loan and the subsequent donations made to the donors' selected charities after the complete amortization of the mortality contingent bond loan or the derivative loan.

FIG. 6 is another sample chart showing the amortization of a mortality contingent bond loan or a derivative loan with the annuity payments. Also shown are the immediate donations made to the donors' selected charities from the mortality contingent bond loan or the derivative loan and the subsequent donations made to the donors' selected charities after the complete amortization of the mortality contingent bond loan or the derivative loan. This chart assumes 100% of the current mortality assumption of the block of 1,000 lives or no change in the current assumed mortality.

FIG. 7 is another sample chart showing the amortization of a mortality contingent bond loan or a derivative loan with the annuity payments. Also shown are the immediate donations made to the donors' selected charities from the mortality contingent bond loan or the derivative loan and the subsequent donations made to the donors' selected charities after the complete amortization of the mortality contingent bond loan or the derivative loan. This chart assumes a 105% of the current mortality assumption of the block of 1,000 lives or a 5% decrease in the current mortality.

### DETAILED DESCRIPTION OF THE PREFERRED EMBODIMENTS

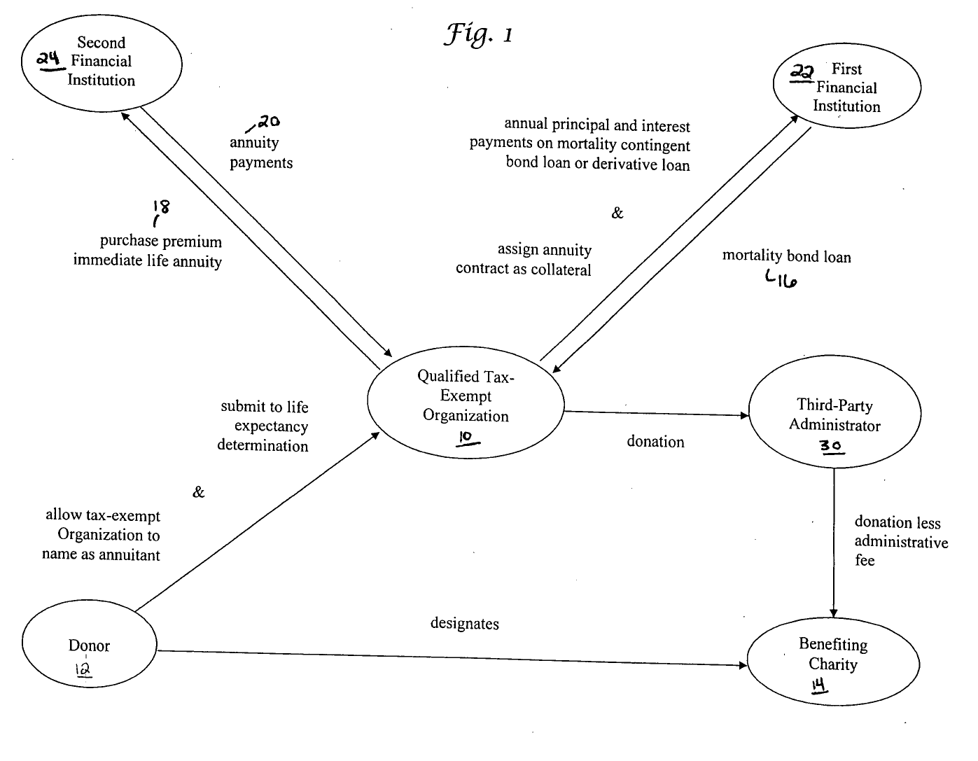

FIGS. 1-7 show a preferred embodiment of the present invention. Together they show a method for benefiting charitable organizations integrating annuities, mortality contingent bonds or derivatives.

FIG. 1 shows the organization of the method in accordance with an embodiment of the present invention. A qualified tax-exempt charitable organization 10 is provided. The qualified tax-exempt charitable organization 10 may be pre-existing or may be specifically formed for participation in the method. Preferably, the qualified tax-exempt charitable organization 10 is a not-for-profit organization recognized as a tax-exempt charitable organization within the meaning of §501(c)(3) of the Internal Revenue Code (“IRC”) and which qualifies as an organization that is not a private foundation within the meaning of §509(a) of the IRC. The qualified tax-exempt charitable organization 10 is preferably chartered to finance money to purchase annuities 18 on the life of a charitable donor 12 to create a benefit for the donor's 12 selected benefiting charity 14. This helps to completely isolate the benefiting charity 14 from any financial or tax liabilities that may be present if the qualified tax-exempt charitable organization 10 was not used.

A donor 12 is preferably a person having a history of charitable giving, either through monetary contributions, endowments or extended active involvement. It should be clearly understood, however, that substantial benefit may be derived from a donor 12 having less of a history of charitable giving or no history at all. Preferably, the donor 12 is between the ages of approximately sixty-five and approximately ninety. Although, it should be understood that substantial benefit may be derived from donors 12 of an alternative age group so long as their life expectancy may be determined. Further preferably, though not required, an ideal donor 12 would be in good health and would not be suffering any terminal illness.

The donor 12 will select at least one benefiting charity 14. The benefiting charity 14 may be one with which the donor 12 has had a previous relationship or may be one to which the donor 12 has not made any previous contribution. Preferably, the benefiting charity 14 will receive at least one initial donation from the qualified tax-exempt charitable organization 10. Further preferably, the benefiting charity 14 will have the potential to receive additional future donations from the qualified tax-exempt charitable organization 10 even after the death of the donor 12.

The method of the present invention integrates annuities, mortality contingent bonds or other mortality-hedging derivatives.

Accordingly, the qualified tax-exempt charitable organization 10 will preferably receive a mortality contingent bond loan or a derivative loan 16 from a first financial institution 22. The qualified tax-exempt charitable organization 10 will then use funds from the mortality bond loan 16 to purchase at least one annuity 18 from a second financial institution 24. Then, the second financial institution 24 will make annuity payments 20 to the qualified tax-exempt charitable organization 10. And finally, the qualified tax-exempt charitable organization 10 will use funds from the annuity payments 20 to amortize the mortality contingent bond loan or the derivative loan 16 issued from the first financial institution 22.

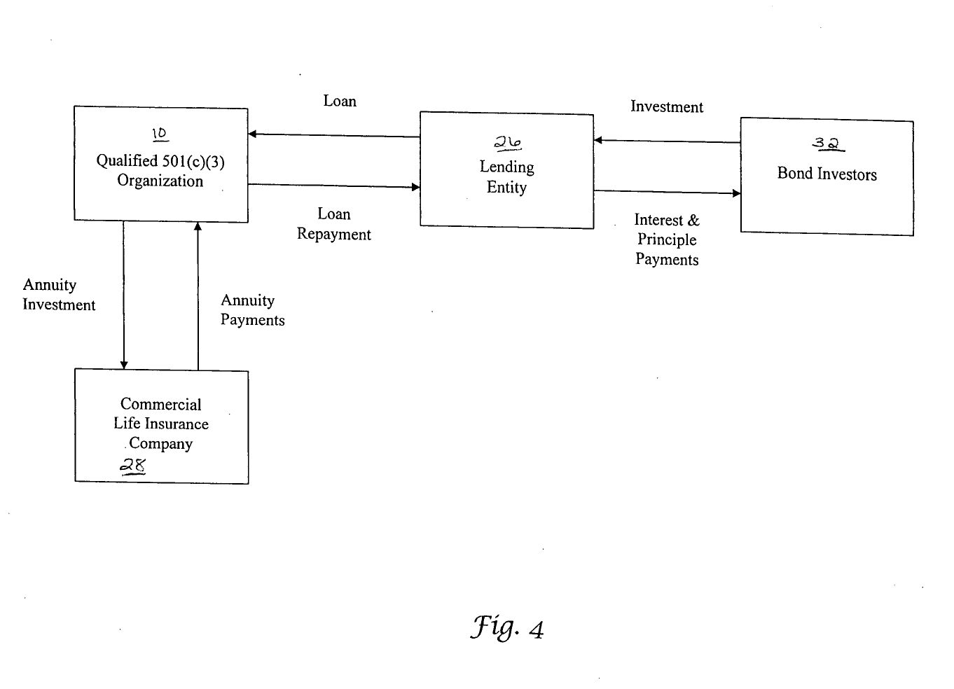

Preferably the annual morality contingent bond loan or the derivative loan interest rate paid to the first financial institution 22 will be based on the longevity of a group of donors 12 (i.e. annuitants) that participate in a block of at least 1,000 donors. Further preferably each donor 12 in the block will submit himself/herself to a life expectancy evaluation to help determine the aggregate life expectancy of the block of donors 12. This will help to more accurately limit the risk to any bond investors 32 (see FIG. 4). While 1,000 is the preferred number of donors 12 belonging to a block, it should be clearly understood that the block may constitute any number of donors 12. It should also be clearly understood that the method of the present invention may be used with only a single donor 12. The first financial institution 22 would preferably receive a portion of its principle each month for the duration of the payout period. By using this method, the first financial institution 22 essentially takes on the mortality risk of the block. Further preferably, though not required, the risk will be assessed by an actuary and an actuarial opinion would be written for each block funded. The mortality risk may then be reduced each year by the amount of their principle returned with each payment.

The annuities 18 are preferably owned by the qualified tax-exempt charitable organization 10 and the donor 12 is named as the annuitant only. The annuities 18 are preferably assigned to the first financial institution 22 (i.e. bond issuer) as collateral for the mortality bond loan 16 and are preferably released to the qualified tax-exempt charitable organization 10 upon complete amortization of the mortality bond loan 16. Further preferably, the second financial institution 24 will pay fixed annuity payments 20 to the qualified tax-exempt charitable organization 10 for the life of the donor 12. At the death of the donor 12, the annuity payments 20 cease and the annuity 18 investment is lost. After the complete amortization of the mortality bond loan 16, the remaining annuity payments 20 paid to the qualified tax-exempt charitable organization, will continue to be donated to all of the benefiting charities 14 named by the donors 12 at the time the annuities 18 were issued. A donor's 12 selected benefiting charity 14 thus continues to receive donations regardless of whether its particular donor 12 is still living.

Preferably, the first financial institution 22 will be a lending entity 26, however it should be clearly understood that the first financial institution 22 may be any kind of entity so long as it is capable of issuing a mortality contingent bond loan or a derivative loan 16. And further preferably, the second financial institution 24 will be either a bank (not shown) or a commercial life insurance company 28. It should be clearly understood, however, that the second financial institution 24 may be a different kind of entity so long as it is capable of issuing annuities 18.

According to the preferred embodiment, a third-party administrator 30 will distribute the charitable donations made by the qualified tax-exempt charitable organization 10 to the donor's 12 benefiting charity 14. This will help to assure that the donor's 12 selected benefiting charity 14 is compliant with the guidelines set forth by the Internal Revenue Service at the time that each donation is made. Preferably, the third-party administrator 30 is another tax-exempt charitable organization, such as the United Way of Northern Utah. Although, it should be clearly understood that further substantial benefit may be derived from the use of a different entity for distributing the charitable donations or from the use of no third-party administrator 30 at all. If desired, the third-party administrator 30 may deduct an administrative fee from the charitable donation before distributing it to the benefiting charity 14.

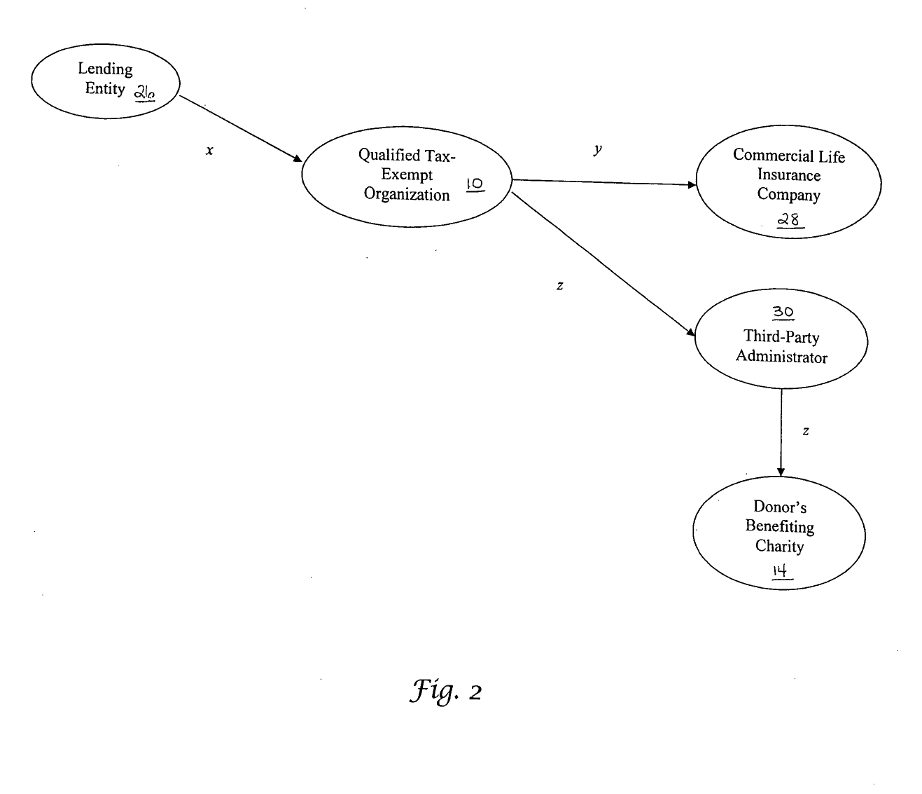

FIG. 2 shows steps of the method of the present invention by which a donor's 12 selected benefiting charity 14 will receive donations. The qualified tax-exempt charitable organization 10 will receive a sum of money x from the lending entity 26 in the form of the mortality contingent bond loan or the derivative loan 16. While most of the funds y will be used to purchase annuities 18 from the commercial life insurance company 28, a portion z of the mortality bond loan 16 may be distributed immediately to the third-party administrator 30 so that it may be distributed to the donor's 12 benefiting charity 14. While this is preferred, it should be clearly understood that substantial benefit may nevertheless be derived from the benefiting charity 14 receiving the donation at a later time or not receiving the portion z of the funds from the mortality contingent bond loan or the derivative loan 18 at all.

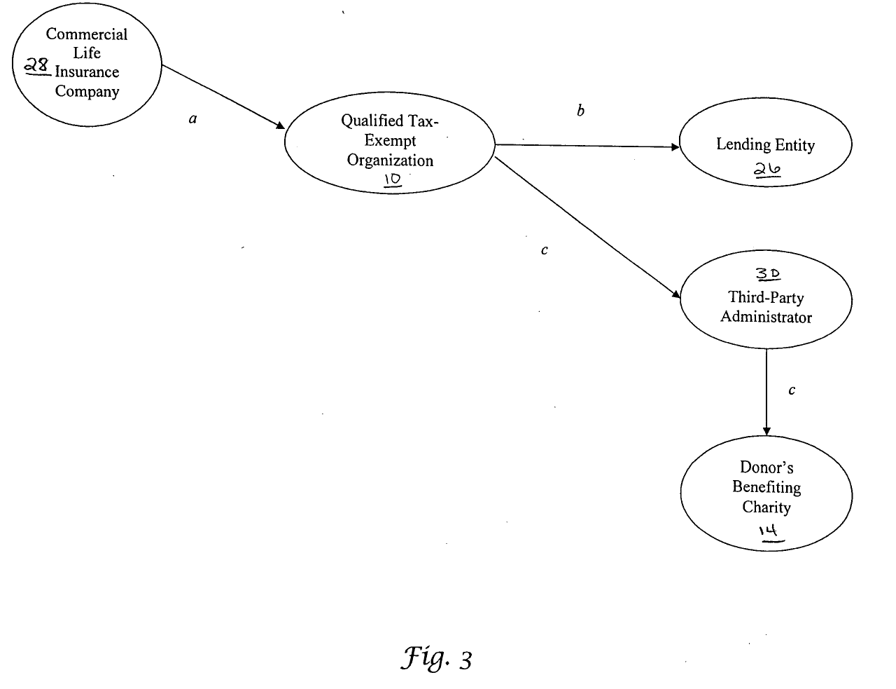

FIG. 3 shows alternative/additional steps of the method of the present invention by which a donor's 12 selected benefiting charity 14 will receive donations. As shown, the qualified tax-exempt charitable organization 10 will receive sums of money a from the commercial life insurance company 28 in the form of the annuity payments 20. Preferably these annuity payments 20 will be made on a fixed schedule, whether it be monthly or annually, semiannually, etc. While most of the funds b from the annuity payments 20 will be used to amortize the mortality contingent bond loan or the derivative loan 18, a portion c of the annuity payments 20 may be used to make donations to the donor's 12 benefiting charity 14. Again, the sum of money c is preferably given by the qualified tax-exempt charitable organization 10 to the third-party administrator 30 so that it may be distributed to the donor's 12 benefiting charity 14. Preferably, these donations c will occur after complete amortization of the mortality bond loan 18, although, it should be clearly understood that substantial benefit may nevertheless be derived from the benefiting charity 14 receiving the donations concurrently with the mortality bond loan 18 payments.

Referring to FIG. 4, the various financial relationships involved in the method are shown. Preferably, bond investors 32 may invest in the lending entities 26 that issue the mortality contingent bond loan or the derivative loans 16 to the qualified tax-exempt charitable organization 10. If the mortality contingent bond loan or the derivative loan 16 is registered, then the bond investors 32 could be members of the general public. If the mortality contingent bond loan or the derivative loan 16 is unregistered, the bond investors 32 could be institutional investors or qualified investors.

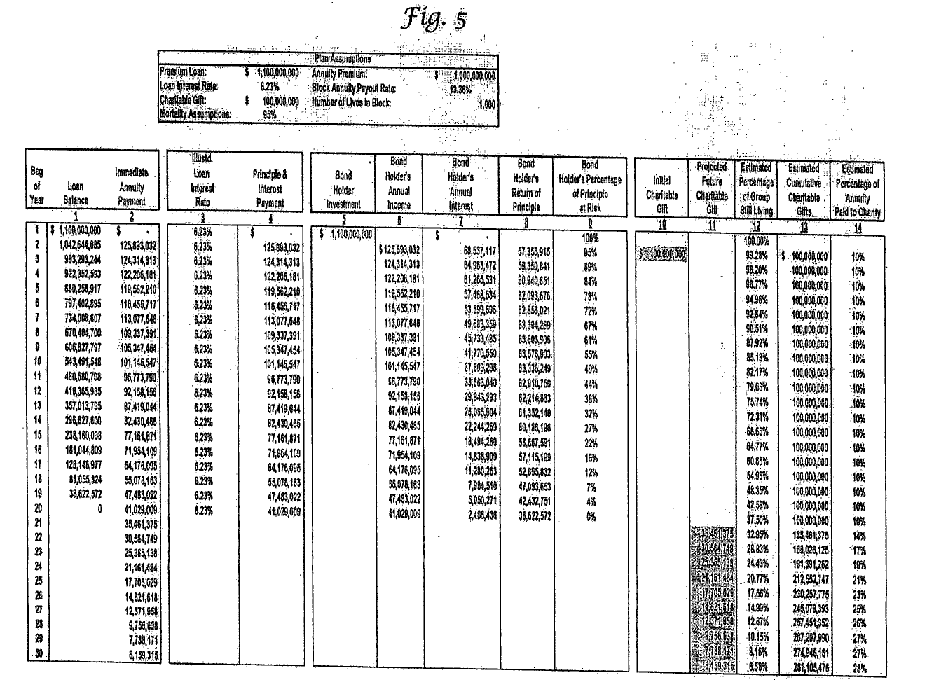

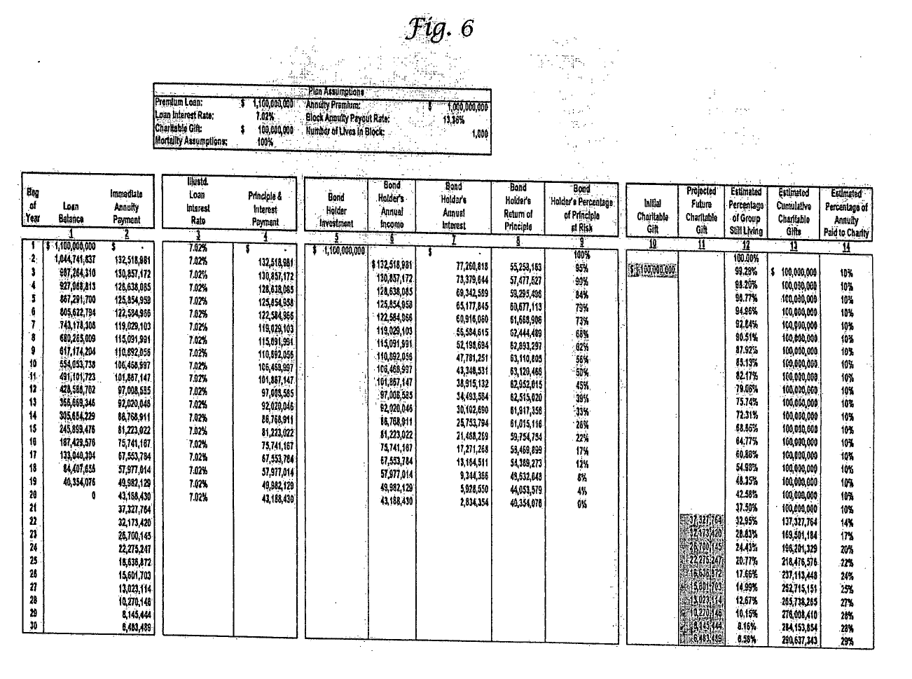

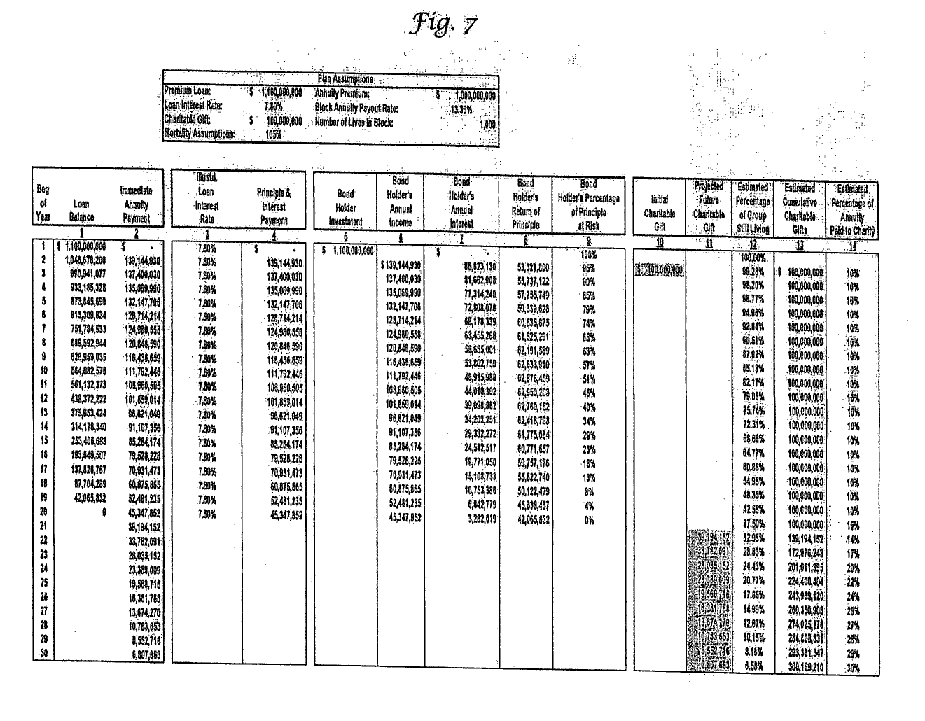

FIG. 5 is a chart showing a sample application of the method of the present invention assuming a 95% of the current mortality assumption of the block of 1000 lives or a 5% increase in the current assumed mortality. FIG. 6 is a similar chart to FIG. 5; however, FIG. 6 assumes a 100% of the current mortality assumption of the block of 1000 lives or no change in the current assumed mortality. FIG. 7 is also a similar chart to FIG. 5; however, FIG. 7 assumes a 105% of the current mortality assumption of the block of 1000 lives or a 5% decrease in the current assumed mortality. It should be clearly understood that the values contained in the charts of FIGS. 5-7 are exemplary only and are not meant as limitations on the function of the method of the present invention.

While the invention has been particularly shown and described with reference to preferred embodiments thereof, it will be understood by those skilled in the art that the foregoing and other changes in form and details may be made therein without departing from the spirit and scope of the invention. For example, certain sections of the Internal Revenue Code have been cited herein. These are the current effective sections of the IRC and any subsequent change to either the number of the Code sections or the wording contained therein does not effect on the spirit or scope of the present invention. As a further example, it should be clearly understood that substantial benefit may also be derived from use of this method with a for-profit organization, rather than a charitable organization as the annuity owner/financier, therefore resulting in the annuitant receiving the monetary benefit rather than his/her selected charity.

I claim:

1. A method of making contributions to charitable organizations comprising the steps of:
selecting a benefiting charity by a donor;
providing a qualified tax-exempt charitable organization;
issuing by a first financial institution at least one of a mortality contingent bond loan and a derivative loan to said qualified tax-exempt charitable organization;
purchasing by said qualified tax-exempt charitable organization of at least one annuity from a second financial institution with at least a portion of funds from said at least one of a mortality contingent bond loan and a derivative loan;
issuing by said second financial institution of at least one annuity to said qualified tax-exempt charitable organization;
paying by said second financial institution of annuity payments to said qualified tax-exempt charitable organization;
amortizing by said tax-exempt charitable organization of said at least one of a mortality contingent bond loan and a derivative loan with at least a portion of said annuity payments received from said second financial institution; and
donating by said tax-exempt charitable organization of at least another portion of said annuity payments received from said second financial institution to said benefiting charity.

2. The method of claim 1 wherein said donor being named as annuitant of said at least one annuity.

3. The method of claim 1 wherein said donor being of a preferred age group.

4. The method of claim 3 wherein said preferred age group being between approximately sixty-five and approximately ninety years of age.

5. The method of claim 1 further comprising the step of determining a life expectancy of said donor.

6. The method of claim 1 further comprising the step of said qualified tax-exempt organization assigning said annuity to said first financial institution as collateral for said at least one of a morality contingent bond loan and a derivative loan.

7. The method of claim 6 further comprising the step of said first financial institution releasing said annuity to said qualified tax-exempt organization upon complete amortization of said at least one of a mortality contingent bond loan and a derivative loan.

8. The method of claim 1 further comprising the step of donating a portion of said at least one of a mortality contingent bond loan and a derivative loan to said benefiting charity shortly after funding of said one of a mortality contingent bond loan and a derivative loan.

9. The method of claim 1 wherein said step of donating at least another portion of said annuity payments received by said tax-exempt charitable organization from said second financial institution to said benefiting charity occurs after complete amortization of said at least one of a mortality contingent bond loan and a derivative loan.

10. The method of claim 8 further comprising the steps of distributing by a third-party administrator of said donations made by said qualified tax-exempt charitable organization to said benefiting charity.

11. The method of claim 10 wherein said third-party administrator being another qualified tax-exempt charitable organization.

12. The method of claim 1 further comprising the step of investing by at least one bond investor in said first financial institution.

13. The method of claim 12 wherein said bond being registered.

14. The method of claim 12 wherein said bond being unregistered.

15. The method of claim 1 wherein said second financial institution being a commercial life insurance company.

16. The method of claim 1 wherein said first financial institution being a lending entity.

17. A method of making contributions to charitable organizations comprising the steps of:
providing at least one benefiting charity selected by at least one of a plurality of donors;
providing a qualified tax-exempt charitable organization;
issuing by at least one lending entity of at least one of a mortality contingent bond loan and a derivative loan to said qualified tax-exempt charitable organization;
purchasing by said qualified tax-exempt charitable organization of a plurality of annuities from at least one commercial life insurance company with at least a portion of funds from said at least one of a mortality contingent bond loan and a derivative loan;
issuing by said at least one commercial life insurance company of said plurality of annuities to said qualified tax-exempt charitable organization;
paying by said at least one commercial life insurance company of annuity payments to said qualified tax-exempt charitable organization;
amortizing by said tax-exempt charitable organization of said at least one of a mortality contingent bond loan and a derivative loan with at least a portion of said annuity payments received from said at least one commercial life insurance company; and
donating by said tax-exempt charitable organization of at least another portion of said annuity payments received from said at least one commercial life insurance company to said at least one benefiting charity.

18. The method of claim 17 wherein each of said plurality of donors being named as an annuitant of at least one of said plurality of annuities.

19. The method of claim 17 further comprising the step of donating by said tax-exempt charitable organization of a portion of said at least one of a mortality contingent bond loan and a derivative loan to said at least one benefiting charity shortly after funding of said at least one of a mortality contingent bond loan and a derivative loan.

20. The method of claim 17 wherein said step of donating by said tax-exempt charitable organization of at least another portion of said annuity payments received from said at least one commercial life insurance company to said at least one benefiting charity occurs after complete amortization of said at least one of a mortality contingent bond loan and a derivative loan.

21. The method of claim 17 wherein said plurality of donors being between approximately sixty-five and approximately ninety years of age.

22. The method of claim 17 further comprising the steps of:
assigning at least one of said plurality of annuities from said qualified tax-exempt organization to said at least one lending entity as collateral for said at least one of a morality contingent bond loan and a derivative loan; and
releasing at least one of said plurality of annuities from said at least one lending entity back to said qualified tax-exempt organization upon complete amortization of said at least one of a mortality contingent bond loan and a derivative loan.

23. The method of claim 19 further comprising the steps of distributing by at least one third-party administrator of said donations made by said qualified tax-exempt charitable organization to said benefiting charity.

24. The method of claim 23 wherein said third-party administrator being another qualified tax-exempt charitable organization.

25. The method of claim 17 wherein said plurality of donors being between approximately sixty-five and approximately ninety years of age.

26. The method of claim 17 further comprising the step of determining an aggregate life expectancy of said plurality of donors.
